(19) United States
(12) Patent Application Publication
(10) Pub. No.: US 2016/0212156 A1
(43) Pub. Date: Jul. 21, 2016

(54) SYSTEM AND METHOD FOR DETECTING MALICIOUS CODE BASED ON APPLICATION PROGRAMMING INTERFACE

(71) Applicant: KOREA INTERNET & SECURITY AGENCY, Seoul (KR)

(72) Inventors: Bo Min CHOI, Seoul (KR); Hong Koo KANG, Seoul (KR); Byung Ik KIM, Seoul (KR); Tong Wook HWANG, Seoul (KR); Tai Jin LEE, Seoul (KR); Young Sang SHIN, Seoul (KR)

(21) Appl. No.: 14/606,278

(22) Filed: Jan. 27, 2015

(30) Foreign Application Priority Data
Jan. 19, 2015 (KR) 10-2015-0008748

(51) Int. Cl. H04L 29/06; G06F 21/56

(52) U.S. Cl. CPC H04L 63/1408; H04L 63/1425; G06F 21/566

(57) ABSTRACT

A system for detecting malicious codes based on API includes: a malicious code management server storing first suspected malicious executable files extracted from traffic to be analyzed collected or inputted; and a virtualization analysis server executing the first suspected malicious executable files received from the malicious code management server, extracting first API call information called by malicious codes in user level and in kernel level, and transmitting the extracted first API call information to the malicious code management server.

### CROSS REFERENCE TO RELATED APPLICATION

The present application claims the benefit of Korean Patent Application No. 10-2015-0008748 filed in the Korean Intellectual Property Office on Jan. 19, 2015, the entire contents of which are incorporated herein by reference.

### BACKGROUND OF THE INVENTION

1. Field of the Invention

The present invention relates to a system and method for detecting malicious codes, and more particularly, to a system and method for detecting malicious codes based on application programming interface (which is referred to as ‘API’) that are capable of detecting the malicious codes generated in Windows environments.

2. Background of the Related Art

A security product performance evaluation organization has recently announced that new one hundred million malicious codes are found until October 2014.

So as to rapidly handle the increasing malicious codes, many studies on the automatic analysis of the malicious codes have been dynamically made.

Accordingly, a system automatically analyzing the malicious code behavior in kernel level has been recently proposed.

However, the conventional malicious code detection system monitors only basic behavior events like files, registers and processes, thus making it impossible to perform detailed behavior analysis.

### SUMMARY OF THE INVENTION

Accordingly, the present invention has been made in view of the above-mentioned problems occurring in the prior art, and it is an object of the present invention to provide a system and method for detecting malicious codes based on API that analyze the API called during the malicious codes executed from the executable files collected in Windows environments, thus detecting detailed malicious behaviors.

To accomplish the above-mentioned object, according to a first aspect of the present invention, there is provided a system for detecting malicious codes based on API, the system including: a malicious code management server storing first suspected malicious executable files extracted from traffic to be analyzed collected or inputted; and a virtualization analysis server executing the first suspected malicious executable files received from the malicious code management server, extracting first API call information called by malicious codes, and transmitting the extracted first API call information to the malicious code management server.

According to the present invention, preferably, the malicious code management server has a malicious behavior analysis management module adapted to apply a previously set malicious code rule set to the first API call information received thereto to detect virtualized malicious behaviors.

According to the present invention, preferably, the malicious code management server collects the traffic to be analyzed from a network traffic sensor connected to network.

According to the present invention, preferably, the traffic to be analyzed includes the first suspected malicious executable files and metadata.

According to the present invention, preferably, the malicious code management server further includes a database adapted to store the traffic to be analyzed, the first API call information and the detected virtualized malicious behaviors.

According to the present invention, preferably, the virtualization analysis server extracts the first API information called by the malicious codes through API hooking in user level and in kernel level and transmits the extracted first API call information to the malicious behavior analysis management module.

According to the present invention, preferably, the malicious behavior analysis management module applies the previously set malicious code rule set including hooking and filtering to the first API call information to detect the virtualized malicious behaviors.

According to the present invention, preferably, the malicious behavior analysis management module extracts second suspected malicious executable files from which the virtualized malicious behaviors are not detected from the first suspected malicious executable files.

According to the present invention, preferably, the system further includes a real-time analysis server receiving the second suspected malicious executable files from the malicious behavior analysis management module, executing the second suspected malicious executable files, and extracting second API call information called by malicious codes.

According to the present invention, preferably, the real-time analysis server extracts the second API information called by the malicious codes through API hooking in user level and in kernel level and transmits the extracted second API call information to the malicious behavior analysis management module.

According to the present invention, preferably, the malicious behavior analysis management module applies the previously set malicious code rule set including hooking and filtering to the second API call information to detect real-time malicious behaviors.

According to the present invention, preferably, the malicious code management server further includes the database adapted to store the detected real-time malicious behaviors.

To accomplish the above-mentioned object, according to a second aspect of the present invention, there is provided a method for detecting malicious codes based on API, the method including the steps of: storing suspected malicious executable files collected or inputted in a malicious code management server; executing the suspected malicious executable files to extract first API call information called by malicious codes in user level and in kernel level by means of a virtualization analysis server; and applying a previously set malicious code rule set to the first API call information by means of the malicious code management server to detect virtualized malicious behaviors.

According to the present invention, preferably, the method further includes the steps of: extracting second API call information called by malicious codes from the suspected malicious executable files from which the virtualized malicious behaviors are not detected and detecting real-time malicious behaviors by means of a real-time analysis server.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing a system for detecting malicious codes based on API according to the present invention;

FIG. 2 is a block diagram showing the detailed configuration of the system for detecting malicious codes based on API according to the present invention;

FIG. 3 shows an example of traffic to be analyzed in a malicious code management server of the system according to the present invention;

FIG. 4 is a block diagram showing the malicious code detecting system having a real-time analysis server according to the present invention;

FIG. 5 is a diagram showing the analysis result of the malicious behaviors based on the API handled through existing system and the system of the present invention (virtualized environments);

FIG. 6 is a diagram showing the analysis result of the malicious codes handled through existing system and the system of the present invention;

FIG. 7 is a diagram showing the handling result of the malicious codes through existing system and the system of the present invention; and

FIG. 8 is a flow chart showing a method for detecting malicious codes based on API according to the present invention.

### DETAILED DESCRIPTION OF THE PREFERRED EMBODIMENTS

Now, an explanation on a system and method for detecting malicious codes based on API according to the present invention will be given with reference to the attached drawings, wherein the corresponding parts in the embodiments of the present invention are indicated by corresponding reference numerals and the repeated explanation on the corresponding parts will be avoided.

<Malicious Behavior Detection>

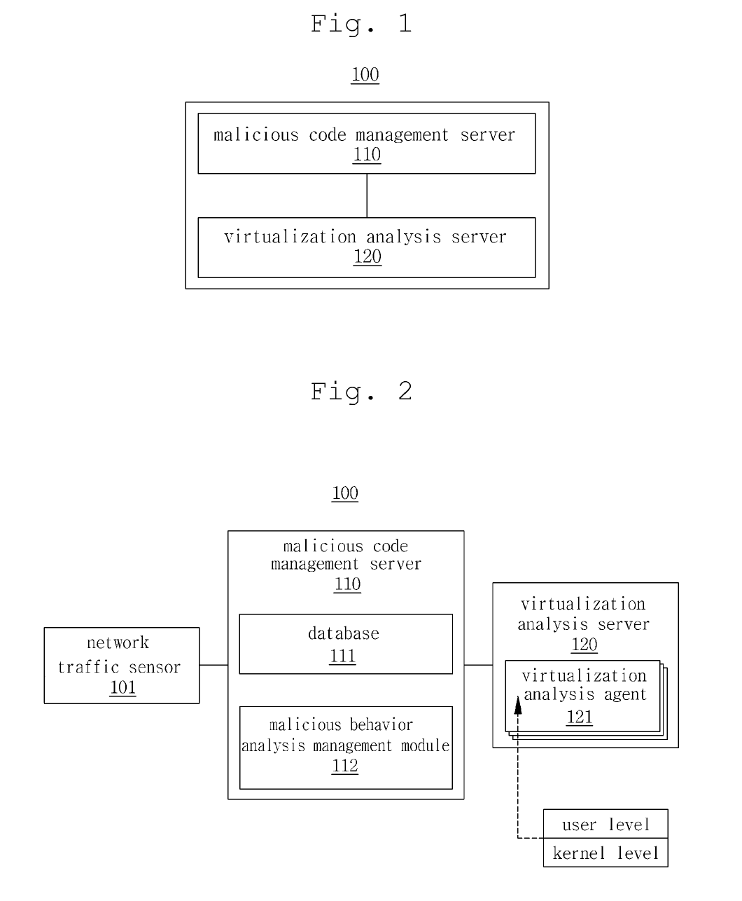

FIG. 1 is a block diagram showing a system for detecting malicious codes based on API according to the present invention.

As shown in FIG. 1, a system 100 for detecting malicious codes based on API according to the present invention includes: a malicious code management server 110 managing all of malicious behavior analyses including API analysis request, analysis sharing, and analysis result inquiry and storage; and a virtualization analysis server 120 detecting malicious codes in virtualized environments from the executable file of the application program executed in Windows environments.

Hereinafter, each part of the malicious code detection system 100 according to the present invention will be explained.

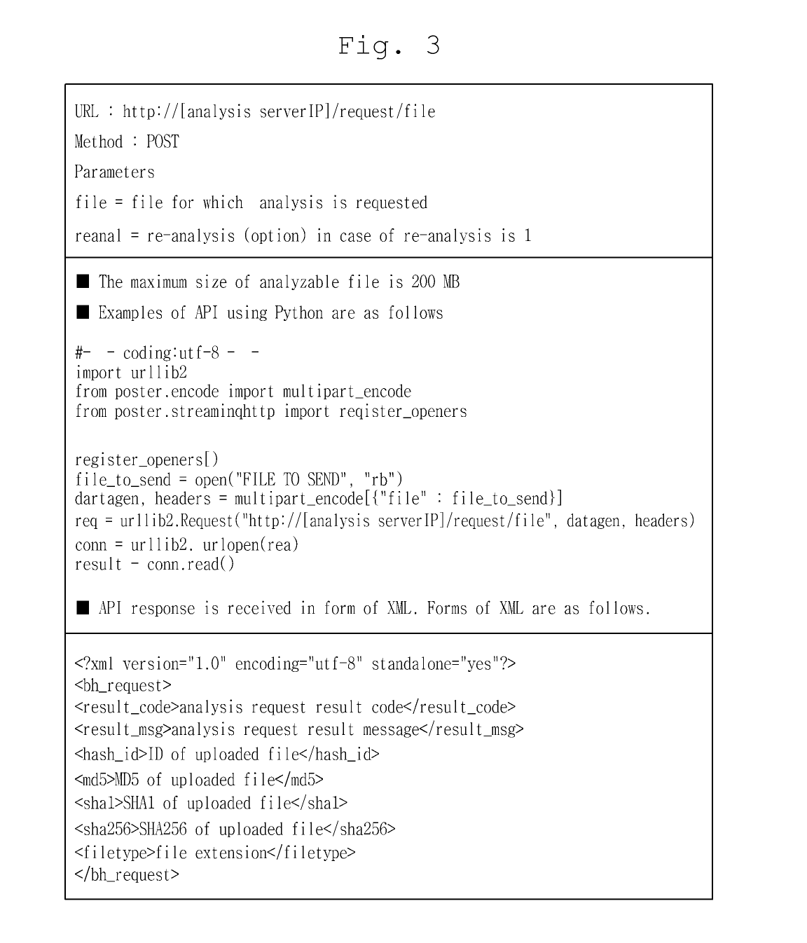

FIG. 2 is a block diagram showing the detailed configuration of the system for detecting malicious codes based on API according to the present invention.

Referring to FIG. 2, the malicious code detection system 100 according to the present invention includes the malicious code management server 110 and the virtualization analysis server 120, so as to detect the malicious behaviors based on the API.

First, the malicious code management server 110 manages all of malicious behavior analyses including API analysis request, analysis sharing of the executable file to be analyzed, and analysis result inquiry and storage. So as to perform such management, the malicious code management server 110 collects traffic to be analyzed in malicious codes from a network traffic sensor 101.

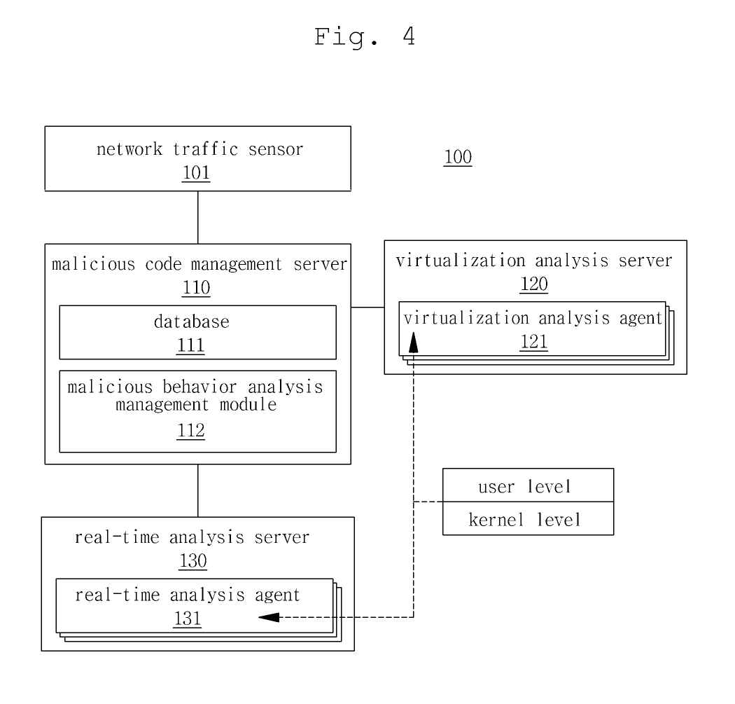

At this time, the network traffic sensor 101 collects the traffic including the executable files of the application program executed in the system operated in the Windows environments through the connection with network, for example, wired/wireless network, extracts the traffic to be analyzed, and transmits the extracted traffic to the malicious code management server 110. An example of the traffic whose analysis is requested is shown in FIG. 3.

Accordingly, the malicious code management server 110 receives the traffic to be analyzed from the network traffic sensor 101, extracts first suspected malicious executable files and various kinds of metadata of the application programs contained in the traffic to be analyzed by using REST API, and stores the extracted result in a database 111.

At this time, the executable files of the application programs collected are desirably PE (portable Executable) files executable in the Windows environments.

However, the executable files of the application programs may be not collected, but received. That is, the malicious code management server 110 manually receives at least one or more executable files and stores the received files in the database 111. At this time, the received executable files of the application programs are desirably PE files executable in the Windows environments. Of course, the executable files are not limited to the PE files.

According to the present invention, the virtualization analysis server 120 drives at least one or more virtualization analysis agents 121 at the same time by using virtualization technology. At this time, the virtualization analysis agents 121 driven cooperatively with each other indicate a Windows system.

If the virtualization analysis agents 121 are driven, they execute the first suspected malicious executable files received from the malicious code management server 110. As a result, the first API call information called by the malicious codes is extracted.

That is, the virtualization analysis server 120 executes the first suspected malicious executable files received from the malicious code management server 110 by using the at least one or more virtualization analysis agents 121 and extracts the first API call information called by the malicious codes.

Desirably, the virtualization analysis server 120 monitors the API information called by the malicious codes through API hooking in user level and in kernel level and extracts the first API call information. If the first API call information is extracted, the malicious behaviors of the malicious codes can be recognized.

That is, the malicious behaviors in the user level and in the kernel level like ‘registration at registry execution position’, ‘file copy’, ‘worm process execution’, ‘log file production on C:W’, and ‘Mutex production for preventing repetition execution’ can be recognized. The extracted first API call information is transmitted to the malicious code management server 110.

Since the first API call information is extracted in user level and in kernel level, the malicious code behavior analysis can be advantageously made on the basis of various APIs.

In this case, the malicious code management server 110 stores the first API call information received from the virtualization analysis server 120 in the database 111.

So as to detect the detailed malicious behaviors using the stored first API call information, in this case, the malicious code management server 110 includes the malicious behavior analysis management module 112.

According to the present invention, the malicious behavior analysis management module 112 applies a previously set malicious code rule set to the first API call information received from the virtualization analysis server 120 to detect virtualized malicious behaviors in the virtualized environments.

At this time, the malicious code rule set includes hooking and filtering. That is, the malicious code rule set including the hooking and filtering is applied to the first API call information, and the first API call information to which the hooking and filtering is applied is compared with the previously set malicious code rule set. If it is checked that the first API call information is the same as the previously set malicious code rule set, the malicious behavior analysis management module 112 detects the virtualized malicious behaviors of the malicious codes. The detected virtualized malicious behaviors are stored in the database 111.

However, all of the malicious codes may be not detected from the first suspected malicious executable files in the virtualized environments. So as to solve the above-mentioned problem, therefore, the system according to the present invention may include a real-time analysis server, and an explanation on the system having the real-time analysis server will be given hereinafter.

FIG. 4 is a block diagram showing the malicious code detecting system having a real-time analysis server according to the present invention.

Referring to FIG. 4, the malicious code detecting system 100 includes the malicious code management server 110 and a real-time analysis server 130. At this time, the malicious code management server 110 includes the malicious behavior analysis management module 112.

First, the malicious behavior analysis management module 112, which is a module analyzing real malicious behaviors, extracts second suspected malicious executable files from which the virtualized malicious behaviors are not detected from the first suspected malicious executable files stored in the database 111. The extracted second suspected malicious executable files are transmitted to the real-time analysis server 130.

To the contrary, the real-time analysis server 130 executes the second suspected malicious executable files by means of at least one or more real-time analysis agents 131 fitted to the real-time environments except the virtualized environments.

That is, the real-time analysis server 130 executes the second suspected malicious executable files received from the malicious behavior analysis management module 112 through the real-time analysis agents 131 and extracts second API call information called by malicious codes.

Desirably, the real-time analysis server 130 monitors the API information called by the malicious codes through API hooking in user level and in kernel level and extracts the second API call information. The extracted second API call information is transmitted to the malicious behavior analysis management module 112.

Accordingly, the malicious behavior analysis management module 112 stores the second API call information received from the real-time analysis agents 131 in the database 111 and applies a previously set malicious code rule set to the stored second API call information to detect real-time malicious behaviors.

At this time, the malicious code rule set is the same as mentioned above, which will be not explained anymore. The detected real-time malicious behaviors are stored in the database 111. Accordingly, the information stored in the database 111 is advantageously used for the analysis of the malicious behaviors if necessary.

According to the present invention, like this, all of the API call information in user level and in kernel level can be extracted in the virtualized environments and/or real-time environments, thus detecting the detailed malicious behaviors of the malicious codes.

<Comparison>

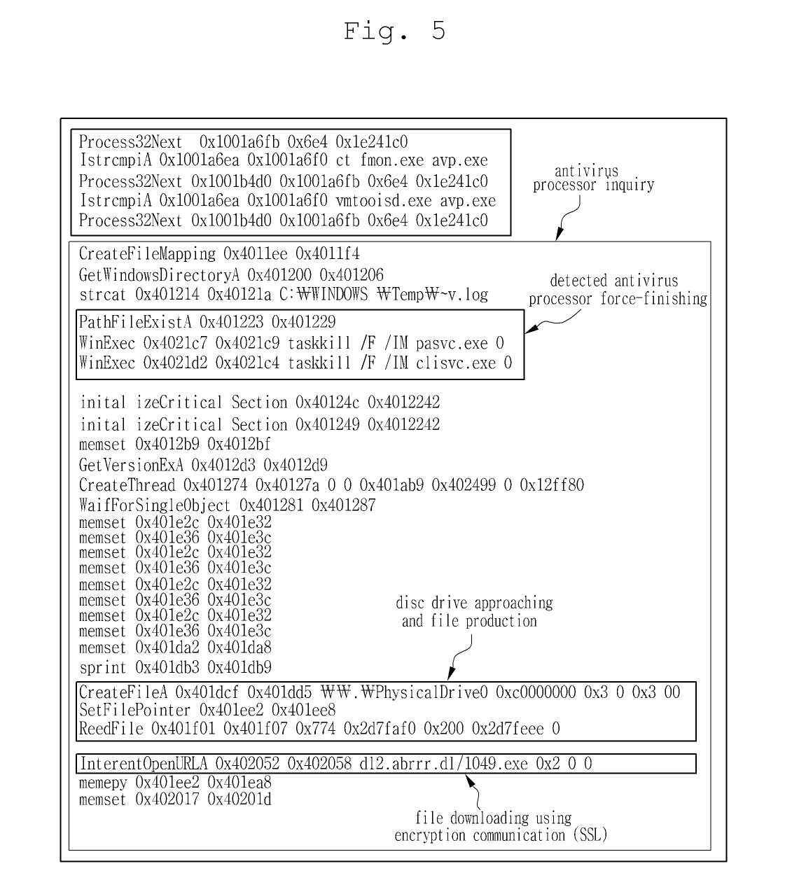

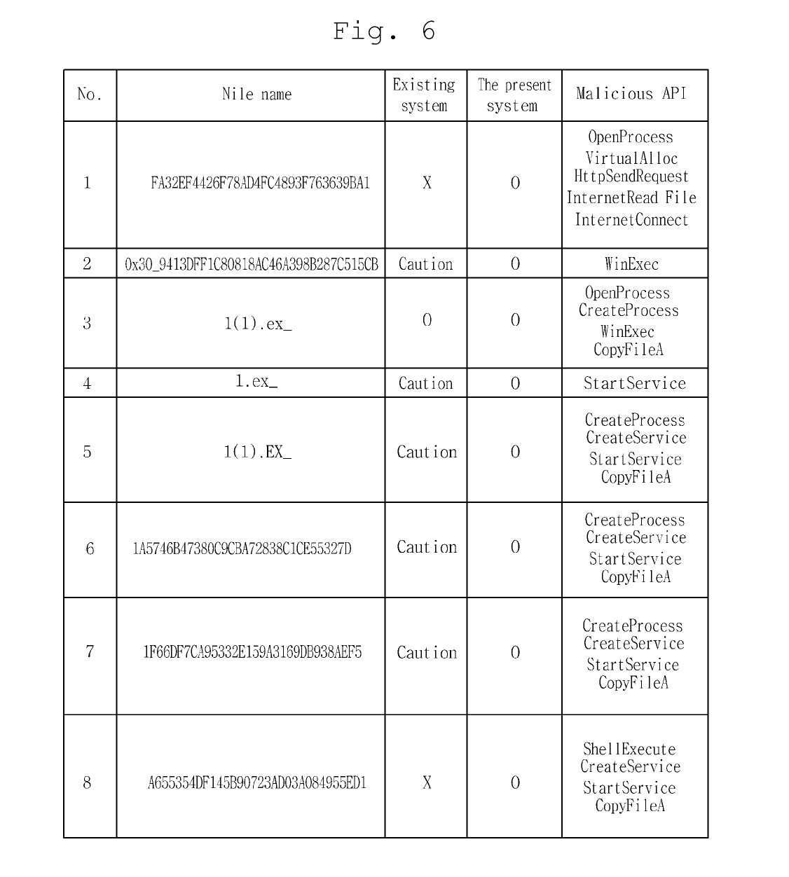

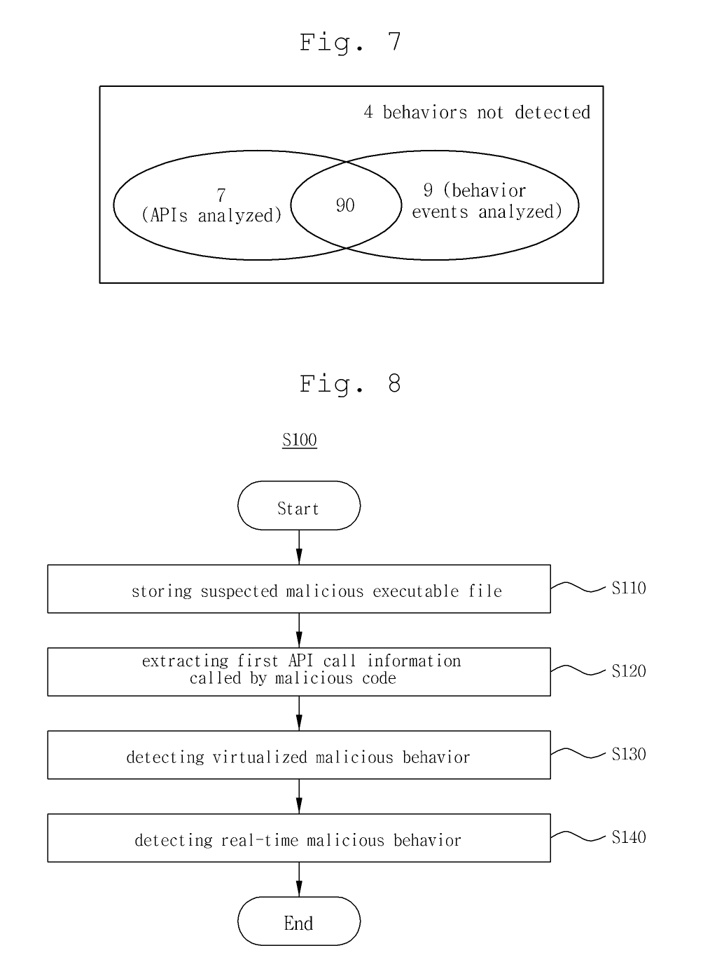

FIG. 5 is a diagram showing the analysis result of the malicious behaviors based on the API handled through existing system and the system of the present invention (virtualized environments), FIG. 6 is a diagram showing the analysis result of the malicious codes handled through existing system and the system of the present invention, and FIG. 7 is a diagram showing the handling result of the malicious codes through existing system and the system of the present invention.

According to the present invention, the experiment as shown in FIG. 5 checks whether the malicious behaviors not detected in the existing analysis system are detected in the malicious code detection system 100 according to the present invention.

According to the experiment, malicious code samples really spread in 2013 are used, and the malicious code samples inquiry vaccine processes on a Windows system and forcedly finish the vaccine processes.

Next, malicious behaviors like the downloading of the executable file from the Web are performed. In the existing analysis system, the behavior for finishing the vaccine process is detected, but the vaccine process inquiry behavior is not detected.

To the contrary, the malicious code detection system 100 according to the present invention performs the vaccine process inquiry behavior and recognizes the detailed malicious behaviors of the malicious codes, as shown in FIG. 5.

In this experiment, the analysis and detection performance of the existing analysis system and the malicious code detection system 100 according to the present invention is measured for the malicious code samples. An example of the analysis result using really spread 110 malicious code samples is shown in FIG. 6.

As shown in FIG. 6, it can be appreciated that the behaviors not detected in the existing analysis system are detected in the malicious code detection system 100 according to the present invention.

As a result, as shown in FIG. 7, the malicious code detection system 100 according to the present invention detects 97 from the 110 malicious code samples used in the experiment, thus exhibiting high performance in the detection rate up to 88% and, further detects even the malicious behaviors (for example, 7 malicious behaviors) of the malicious codes not detected in the existing analysis system.

<Malicious Code Detection Method>

FIG. 8 is a flow chart showing a method for detecting malicious codes based on API according to the present invention.

As shown in FIG. 8, the method for detecting malicious codes based on API according to the present invention includes the steps of: storing suspected malicious executable files collected or inputted (at step S110); executing the suspected malicious executable files to extract first API call information called by malicious codes in user level and in kernel level (at step S120); applying a previously set malicious code rule set to the first API call information to detect virtualized malicious behaviors (at step S130); and extracting second API call information called by malicious codes from second suspected malicious executable files from which the virtualized malicious behaviors are not detected to detect real-time malicious behaviors (at step S140).

According to the present invention, at the step S110, the traffic to be analyzed in malicious codes is first collected from a network traffic sensor 101 by means of a malicious code management server 110.

At this time, the network traffic sensor 101 collects the traffic including the executable files of the application programs executed in the systems operated in the Windows environments through the connection with network, for example, wired/wireless networks, extracts the traffic to be analyzed, and transmits the extracted traffic to the malicious code management server 110.

Accordingly, at the step S110, the traffic to be analyzed is received from the network traffic sensor 101, and first suspected malicious executable files and various kinds of metadata of the application programs contained in the traffic to be analyzed are extracted and stored in a database 111 by using REST API.

At this time, the collected executable files of the application programs are desirably PE (portable Executable) files executable in the Windows environments.

However, the executable files of the application programs may be not collected, but received. That is, at the step S110, at least one or more executable files are manually received and stored in the database 111. At this time, the inputted executable files of the application programs are desirably PE files executable in the Windows environments. Of course, the executable files are not limited to the PE files.

According to the present invention, at the step S120, at least one or more virtualization analysis agents 121 are at the same time driven by using virtualization technology. At this time, the virtualization analysis agents 121 driven cooperatively with each other indicate a Windows system.

If the virtualization analysis agents 121 are driven, the first suspected malicious executable files received from the malicious code management server 110 are executed in the virtualization analysis agents 121. As a result, the first API call information called by malicious codes is extracted.

That is, at the step S120, the first suspected malicious executable files received from the malicious code management server 110 are executed by using the at least one or more virtualization analysis agents 121, and the first API call information called by the malicious codes is extracted in a virtualization analysis server 120.

Desirably, the API information called by the malicious codes is monitored through API hooking in user level and in kernel level to extract the first API call information. If the first API call information is extracted, the malicious behaviors of the malicious codes can be recognized.

That is, the malicious behaviors in user level and in kernel level like ‘registration at registry execution position’, ‘file copy’, ‘worm process execution’, ‘log file production on C:W’, and ‘Mutex production for preventing repetition execution’ can be recognized. The extracted first API call information is transmitted from the virtualization analysis server 120 to the malicious code management server 110.

Since the first API call information is extracted both in user level and in kernel level, the malicious code behavior analysis can be advantageously made on the basis of various APIs.

In this case, the malicious code management server 110 stores the first API call information received from the virtualization analysis server 120 in the database 111.

So as to detect the detailed malicious behaviors using the stored first API call information, at the step S130, a previously set malicious code rule set is applied to the first API call information received from the virtualization analysis server 120 through a malicious behavior analysis management module 112 to detect the virtualized malicious behaviors in the virtualized environments.

At this time, the malicious code rule set includes hooking and filtering. That is, the malicious code rule set including the hooking and filtering is applied to the first API call information, and the first API call information to which the hooking and filtering is applied is compared with the previously set malicious code rule set. If it is checked that the first API call information is the same as the previously set malicious code rule set, the virtualized malicious behaviors of the malicious codes are detected in the malicious behavior analysis management module 112. The detected virtualized malicious behaviors are stored in the database 111 of the malicious code management server 110.

However, all of the malicious codes may be not detected from the first suspected malicious executable files in the virtualized environments. Accordingly, as the step S140, the second suspected malicious executable files from which the virtualized malicious behaviors are not detected are extracted from the first suspected malicious executable files stored in the database 111. The extracted second suspected malicious executable files are transmitted to the real-time analysis server 130.

After that, the second suspected malicious executable files received from the malicious behavior analysis management module 112 are executed through real-time analysis agents 131 of the real-time analysis server 130, and the second API call information called by malicious codes is extracted in the real-time analysis server 130.

Desirably, the API information called by the malicious codes is monitored through API hooking in user level and in kernel level to extract the second API call information in the real-time analysis server 130. The extracted second API call information is transmitted to the malicious behavior analysis management module 112.

Accordingly, at the step S140, the second API call information received from the real-time analysis agents 131 is stored in the database 111, and a previously set malicious code rule set is applied to the stored second API call information to detect real-time malicious behaviors in the malicious behavior analysis management module 112.

At this time, the malicious code rule set is the same as mentioned above, which will be not explained anymore. The detected real-time malicious behaviors are stored in the database 111. Accordingly, the information stored in the database 111 is advantageously used for the analysis of the malicious behaviors if necessary.

According to the present invention, like this, all of the API call information in user level and in kernel level can be extracted in the virtualized environments and/or real-time environments, thus detecting the detailed malicious behaviors of the malicious codes.

As described above, the system and method for detecting the malicious codes based on the API extract and analyze the API called during the malicious codes are operated in user level and in kernel level, thus detecting the behaviors not detected in the existing behavior monitoring system to provide the detailed behavior analysis results.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for detecting malicious codes based on API, the system comprising:
a malicious code management server storing first suspected malicious executable files extracted from traffic to be analyzed collected or inputted; and
a virtualization analysis server executing the first suspected malicious executable files received from the malicious code management server, extracting first API call information called by malicious codes in user level and in kernel level, and transmitting the extracted first API call information to the malicious code management server,
wherein the malicious code management server has a malicious behavior analysis management module adapted to apply a previously set malicious code rule set to the first API call information received thereto to detect virtualized malicious behaviors.

2. The system according to claim 1, wherein the malicious code management server collects the traffic to be analyzed from a network traffic sensor connected to network.

3. The system according to claim 2, wherein the traffic to be analyzed comprises the first suspected malicious executable files and metadata.

4. The system according to claim 1, wherein the malicious code management server further comprises a database adapted to store the traffic to be analyzed, the first API call information and the detected virtualized malicious behaviors.

5. The system according to claim 1, wherein the virtualization analysis server extracts the first API information called by the malicious codes through API hooking in user level and in kernel level and transmits the extracted first API call information to the malicious behavior analysis management module.

6. The system according to claim 5, wherein the malicious behavior analysis management module applies the previously set malicious code rule set including hooking and filtering to the first API call information to detect the virtualized malicious behaviors.

7. The system according to claim 1, wherein the malicious behavior analysis management module extracts second suspected malicious executable files from which the virtualized malicious behaviors are not detected from the first suspected malicious executable files.

8. The system according to claim 7, further comprising a real-time analysis server receiving the second suspected malicious executable files from the malicious behavior analysis management module, executing the second suspected malicious executable files, and extracting second API call information called by malicious codes.

9. The system according to claim 8, wherein the real-time analysis server extracts the second API information called by the malicious codes through API hooking in user level and in kernel level and transmits the extracted second API call information to the malicious behavior analysis management module.

10. The system according to claim 9, wherein the malicious behavior analysis management module applies the previously set malicious code rule set including hooking and filtering to the second API call information to detect real-time malicious behaviors.

11. The system according to claim 10, wherein the malicious code management server further comprises the database adapted to store the detected real-time malicious behaviors.

12. A method for detecting malicious codes based on API, the method comprising the steps of:
storing suspected malicious executable files collected or inputted in a malicious code management server;
executing the suspected malicious executable files to extract first API call information called by malicious codes in user level and in kernel level by means of a virtualization analysis server; and
applying a previously set malicious code rule set to the first API call information by means of the malicious code management server to detect virtualized malicious behaviors.

13. The method according to claim 12, further comprising the steps of: extracting second API call information called by malicious codes from the suspected malicious executable files from which the virtualized malicious behaviors are not detected and detecting real-time malicious behaviors by means of a real-time analysis server.
